(19) United States
(12) Patent Application Publication
(10) Pub. No.: US 2012/0043699 A1
(43) Pub. Date: Feb. 23, 2012

(54) METHOD FOR PRODUCING ENDLESS BELT

(75) Inventors: Hirohisa KATO, Mie (JP); Shinya AKATSUKA, Mie (JP)

(73) Assignee: FUJI XEROX CO., LTD., TOKYO (JP)

(21) Appl. No.: 13/098,783

(22) Filed: May 2, 2011

(30) Foreign Application Priority Data
Aug. 23, 2010 (JP) 2010-186510

(51) Int. Cl. B29C 33/46

(52) U.S. Cl. 264/316

(57) ABSTRACT

A method for producing an endless belt includes partially covering a circumferential surface of a cylindrical mold with a covering film member nonadhesive to the mold by fixing the covering film member with a fixing member, applying a resin material to the circumferential surface of the mold, curing the resin material to form a resin film, and removing the resin film from the mold by blowing a gas into a gap between the circumferential surface of the mold and the covering film member.

### CROSS-REFERENCE TO RELATED APPLICATIONS

This application is based on and claims priority under 35 USC 119 from Japanese Patent Application No. 2010-186510 filed Aug. 23, 2010.

### BACKGROUND

(i) Technical Field

The present invention relates to methods for producing endless belts.

(ii) Related Art

Belts of plastic films used for photoconductor units, charging units, transfer units, and fixing units of image-forming apparatuses may be seamless endless belts. The endless belts may be formed of polyimide or polyamideimide.

### SUMMARY

According to an aspect of the invention, there is provided a method for producing an endless belt. This method includes partially covering a circumferential surface of a cylindrical mold with a covering film member nonadhesive to the mold by fixing the covering film member with a fixing member, applying a resin material to the circumferential surface of the mold, curing the resin material to form a resin film, and removing the resin film from the mold by blowing a gas into a gap between the circumferential surface of the mold and the covering film member.

### BRIEF DESCRIPTION OF THE DRAWINGS

Exemplary embodiments of the present invention will be described in detail based on the following figures, wherein:

FIG. 1 is a schematic diagram showing a mold partially covered with a covering film member in a method for producing an endless belt according to a first exemplary embodiment of the present invention;

FIG. 2 is a schematic diagram showing a mold partially covered with a covering film member in a method for producing an endless belt according to a modification of the first exemplary embodiment;

FIG. 3 is a schematic diagram showing a mold partially covered with a covering film member in a method for producing an endless belt according to a second exemplary embodiment of the present invention;

FIG. 4 is a schematic diagram showing a mold partially covered with a covering film member in a method for producing an endless belt according to a modification of the second exemplary embodiment;

FIG. 5 is a schematic diagram showing a mold partially covered with a covering film member in a method for producing an endless belt according to a third exemplary embodiment of the present invention;

FIG. 6 is a schematic diagram showing a mold partially covered with a covering film member in a method for producing an endless belt according to a modification of the third exemplary embodiment;

FIG. 7 is a schematic diagram illustrating dip coating;

FIGS. 8A and 8B are schematic diagrams illustrating ring coating;

FIGS. 9A and 9B are schematic diagrams illustrating coating using a rotary coating apparatus, where FIG. 9A is a side view, and FIG. 9B is a front view;

FIG. 10 is a schematic diagram of a core and a cutting mold;

FIG. 11 is a schematic diagram illustrating film cutting; and

FIG. 12 is a schematic sectional view of a cutting mold.

### DETAILED DESCRIPTION

Methods for producing endless belts according to exemplary embodiments of the present invention will now be described in detail.

A method for producing an endless belt according to an exemplary embodiment of the present invention includes applying a resin material to a circumferential surface of a mold partially covered with a nonadhesive covering film member so as to partially cover the covering film member to form a coating, drying the coating by heating to form a resin film, and removing the resin film from the mold by blowing a gas into a gap between the nonadhesive covering film member and the circumferential surface of the mold to form airspace between the resin film and the circumferential surface of the mold.

That is, the method for producing an endless belt according to this exemplary embodiment includes the following steps:

### (1) Covering Step

A circumferential surface of a cylindrical mold is partially covered with a covering film member nonadhesive to the mold by fixing the covering film member with a fixing member.

### (2) Coating Step

A resin material is applied to the circumferential surface of the mold so as to partially cover the covering film member.

### (3) Curing Step

The resin material is cured to form a resin film.

### (4) Removing Step

The resin film is removed from the mold by blowing a gas into a gap between the circumferential surface of the mold and the covering film member.

In the method for producing an endless belt according to this exemplary embodiment, the covering film member is in close contact with the circumferential surface of the mold in the coating step (2) and the curing step (3). In the removing step (4), on the other hand, because the covering film member is nonadhesive to the mold, a gas is blown into a gap between the covering film member and the circumferential surface of the mold to form airspace between the resin film and the circumferential surface of the mold, thus removing the resin film from the mold.

In the curing step (3), additionally, a gas emitted during the curing reaction of the resin material leaks from the gap between the covering film member and the circumferential surface of the mold. This prevents the endless belt from blistering with the gas.

The method may further include a step of removing the covering film member or a step of removing the fixing member fixing the covering film member to the circumferential surface of the mold before the removing step (4). Alternatively, without such removing steps, the covering film member and the fixing member may be removed from the mold together with the resin film in the removing step (4).

The removal of the covering film member and the fixing member from the mold together with the resin film in the removing step (4) eliminates the need for additional steps of removing the covering film member and the fixing member.

Position Covered with Covering Film Member

In the method for producing an endless belt according to this exemplary embodiment, the covering film member may cover the circumferential surface of the mold partially circumferentially.

The resin material may enter the gap between the covering film member and the circumferential surface of the mold in the coating step (2). Accordingly, a mold repeatedly used for production of endless belts may be contaminated with the resin material. However, the contaminated area is reduced if the covering film member covers the circumferential surface of the mold only partially circumferentially, rather than entirely circumferentially.

The covering film member may be arranged at each axial end of the mold, and the resin material may be applied so as to partially cover each of the covering film members. This allows the gas to blown into gaps between the circumferential surface of the mold and the covering film members from both axial ends of the mold.

Position Fixed with Fixing Member

In the above case where the covering film member covers the circumferential surface of the mold partially circumferentially, the covering film member may be fixed to the mold with the fixing member such that, in the removing step (4), the gas is blown into the gap between the circumferential surface of the mold and the covering film member from a substantially circumferential direction in an area of the covering film member not covered with the resin film.

That is, the covering film member may be fixed to the mold with the fixing member such that the gas is blown into the gap between the circumferential surface of the mold and the covering film member from a substantially circumferential direction in the area of the covering film member not covered with the resin film. In other words, the circumferential sides of the covering film member may be unfixed in the area not covered with the resin film. This allows the gas to be blown through those positions to form airspace between the circumferential surface of the mold and the resin film, thus removing the resin film from the mold.

### First Exemplary Embodiment

A method for producing an endless belt according to a first exemplary embodiment of the present invention will now be described in detail for each step, although the method may include various other steps.

### (1) Covering Step

### Mold

First, a mold used in the method for producing an endless belt according to this exemplary embodiment will be described. The mold may be formed of a metal such as aluminum, stainless steel, nickel, or copper. The length of the mold in the axial direction is equal to or larger than the width of the endless belt to be produced. To make allowance for ineffective areas to be formed at both ends, the length of the mold in the axial direction may be 2% to 40% or about 2% to 40% longer than the length of the endless belt to be produced in the axial direction. The outer diameter of the mold is set depending on the diameter of the endless belt to be produced. The wall thickness of the mold is large enough to ensure sufficient strength as a mold.

The mold used is cylindrical. If the mold is heavy, retaining plates may be attached to both ends thereof. The retaining plates may be configured to hold the mold at both ends thereof or to be fitted into the mold. In addition, the mold and/or the retaining plates may have, for example, a step or a cut. The retaining plates may be attached with screws or by welding.

To prevent the resin film from adhering to the surface of the mold, the surface of the mold may have mold release properties. Examples of methods therefor include plating with chromium or nickel, coating with a fluorocarbon or silicone resin, and coating with a mold release agent.

On the other hand, if the resin film is formed of polyimide, it generates large amounts of gases, such as volatilized residual solvent and water vapor, during the reaction by heating. This tendency is particularly noticeable if the polyimide film is thick, specifically, more than 50 μm thick.

Accordingly, as disclosed in Japanese Unexamined Patent Application Publication No. 2002-160239, the surface of the mold may be roughened to an Ra of 0.2 to 2 μm. Examples of methods for roughening include blasting, cutting, and rubbing with sand paper. This allows the gases generated from the polyimide to be released outside through slight gaps formed between the mold and the polyimide film.

### Covering

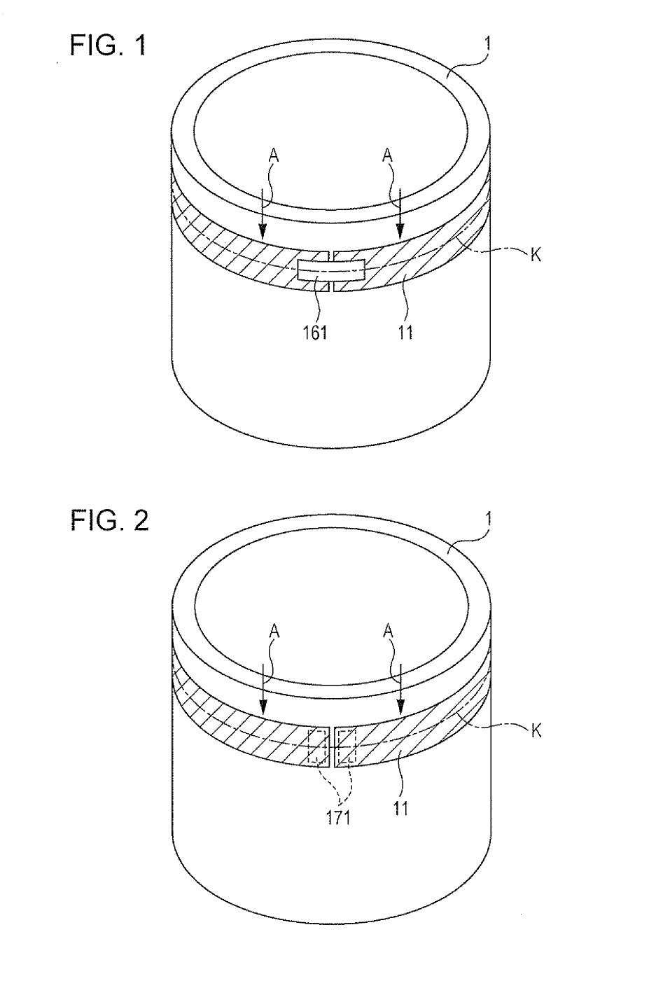

In the first exemplary embodiment, before the coating step (2), as shown in FIG. 1, the circumferential surface of a mold 1 is covered with a covering film member 11 by winding the covering film member 11 around a portion of the circumferential surface of the mold 1 circumferentially by one turn (around the “portion of the circumferential surface” entirely circumferentially) and fixing both ends of the covering film member 11 with a single-sided adhesive tape as a fixing member 161. Although FIG. 1 shows only one axial end of the mold 1, the covering film member 11 may be arranged at each axial end. This also applies to the other exemplary embodiments described later.

As a modification of the first exemplary embodiment, as shown in FIG. 2, the circumferential surface of the mold 1 may be covered with the covering film member 11 by winding the covering film member 11 around the circumferential surface of the mold 1 circumferentially by one turn and fixing the covering film member 11 with double-sided adhesive tapes, as fixing members 171, stuck to both ends of the covering film member 11 in the longitudinal direction. In FIG. 2, the double-sided adhesive tapes are stuck to the inner surface of the covering film member 11, that is, the surface opposite the circumferential surface of the mold 1. Instead of the double-sided adhesive tapes, an adhesive may be used as the fixing members 171.

The covering film member 11 may be any film member that is nonadhesive to the mold 1 (nonadhesive within the temperature range where it is to be used, namely, room temperature (20° C.) to the heating temperature in the curing step (3)) and that is resistant to the heating temperature in the curing step (3).

Examples of such film members include a film of the resin material used for production of endless belts in this exemplary embodiment, a polyimide film, and a polyamideimide film. In particular, a film of the resin material used for production of endless belts may be used. For example, a scrap (portion removed by cutting) produced during the production of endless belts may be used.

The single-sided adhesive tape, double-sided adhesive tape, or adhesive used may be resistant to the heating temperature in the curing step (3).

Examples of materials of single-sided or double-sided adhesive tapes include polyimide, polyester, and fluorocarbon resins. Examples of adhesives include polyimide, polyamideimide, polybenzimidazole, phenolic, silicone, and acrylic resins. In particular, the same resin as the resin material used for production of endless belts may be used.

### (2) Coating Step

In the first exemplary embodiment, the resin material is applied to the circumferential surface of the mold 1 so as to partially cover the covering film member 11. In FIGS. 1 and 2, the resin material is applied to an area below a boundary K between the area where the resin material is applied and the area where the resin material is not applied.

Examples of resin materials (resin solutions for forming films) include polyimide, polyamideimide, polycarbonate, polyester, polyamide, and polyarylate. If the material is a thermoplastic resin, a solution thereof is used. If the material is a non-thermoplastic resin (thermosetting resin) such as polyimide, a precursor thereof is used. The concentration, viscosity, and other properties of the resin material are appropriately selected.

For example, various polyimide precursors may be used, including a combination of 3,3′,4,4′-biphenyltetracarboxylic dianhydride (BPDA) and p-phenylenediamine (PDA), a combination of BPDA and 4,4′-diaminodiphenyl ether, and a combination of pyromellitic dianhydride (PMDA) and 4,4′-diaminodiphenyl ether. It is also possible to use a mixture of two or more polyimide precursors or to use a mixture of acid or amine monomers for copolymerization.

Examples of solvents for polyimide precursors include aprotic polar solvents such as N-methylpyrrolidone, N,N-dimethylacetoamide, and acetoamide. The mixing ratio, concentration, viscosity, and other properties of the polyimide precursor solution are appropriately selected.

The solution may be applied to the circumferential surface of the mold 1 by various methods, including dip coating, in which the mold 1 is dipped into and then lifted from the solution, flow coating, in which the solution is discharged onto the surface of the mold 1 while rotating the mold 1, and blade coating, in which a coating is leveled with a blade.

The phrase “applied to the mold” means that the solution is applied to the circumferential surface of the mold or, if a layer is arranged thereon, to the surface of the layer. In addition, the phrase “the mold is lifted” refers to a change in the position relative to the liquid surface during the coating; it includes the case where the liquid surface is lowered without changing the height of the mold.

If the solution is applied by dip coating, a method for controlling the thickness of a film with a ring may be used, as disclosed in Japanese Unexamined Patent Application Publication No. 2002-91027.

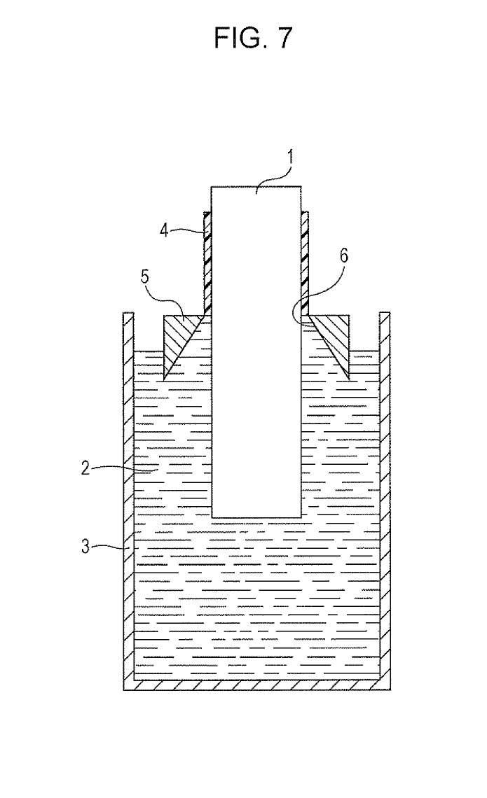

FIG. 7 is a schematic diagram showing an example of an apparatus used in dip coating for controlling the thickness of a film with a ring, where only the relevant part is shown, and the retaining plates for the mold 1 and other devices are omitted.

In this dip coating, as shown in FIG. 7, a ring 5 having a circular hole 6 larger than the outer diameter of the mold 1 is floated in a solution 2 put in a coating bath, and the mold 1 is lifted through the circular hole 6 to form a coating 4.

The ring 5 is formed of a material, such as a metal or plastic, that is resistant to the solvent in the solution 2. The ring 5 may be hollow so that it floats easily, or the circumferential surface of the ring 5 or the coating bath 3 may have legs or arms supporting the ring 5 to prevent the ring 5 from sinking.

For example, the ring 5 may be floated in the solution 2, be supported by a roller or bearing, or be supported by air pressure to allow it to move freely over the solution 2 horizontally. In addition, the ring 5 may be temporarily fixed in the center of the coating bath 3.

Because the thickness of the coating 4 is regulated by the gap between the circumferential surface of the mold 1 and the inner surface of the circular hole 6, the inner diameter of the circular hole 6 is adjusted depending on the intended thickness. Because the gap also determines variations in the thickness of the coating 4, the deviation from circularity of the circular hole 6 may be taken into account. The deviation from circularity is preferably 20 μm or less, more preferably 10 μm or less, and most preferably 0 μm.

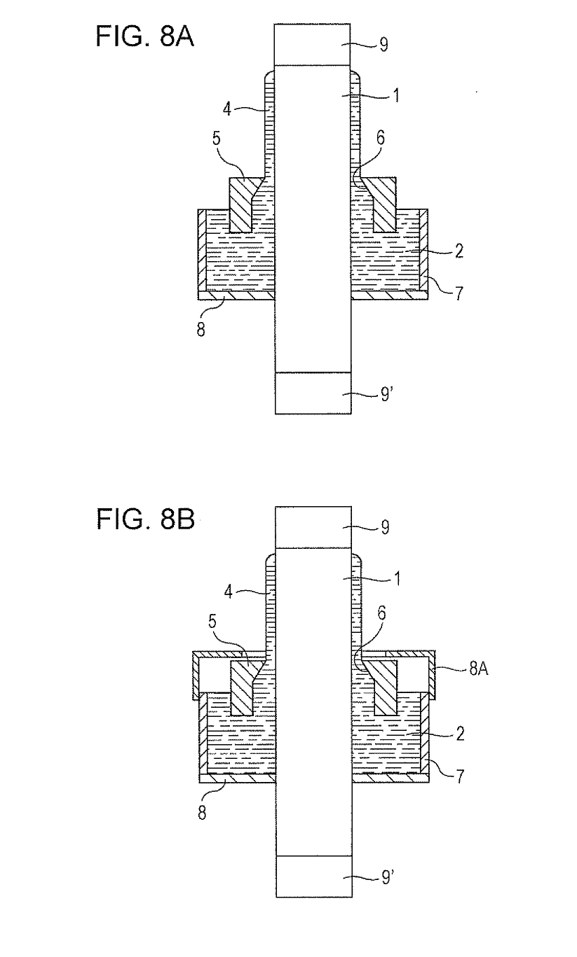

The inner wall surface of the circular hole 6 (inner circumferential surface of the ring 5) may have any shape including a wider lower portion to be dipped in the solution 2 and a narrower upper portion, for example, an inclined linear slope, as shown in FIG. 7, or a combined slope, as shown in FIGS. 8A and 8B. In addition, the surface may be stepped or curved.

During the coating, the mold 1 is lifted through the circular hole 6. The lifting speed may be 0.1 to 1.5 m/min. The solid content of the polyimide precursor solution used for this coating method may be 10% to 40% by mass, and the viscosity thereof may be 1 to 100 Pa·s.

In addition, the coating apparatus used for dip coating may include a mold holder that holds the mold 1 and a first moving unit that moves the holder vertically and/or a second moving unit that moves the coating bath 3 vertically.

In the coating step, as described above, the ring coating illustrated in FIGS. 8A and 8B may also be used. FIGS. 8A and 8B are schematic diagrams showing an example of an apparatus used for ring coating.

FIGS. 8A and 8B differ from FIG. 7 in that a ring seal 8 having a hole slightly smaller than the outer diameter of the mold 1 is arranged at the bottom of a ring coating bath 7. When the solution 2 is put into the ring coating bath 7 with the mold 1 inserted in the center of the ring seal 8, the solution 2 does not leak out. The mold 1 is gradually lifted from the bottom to the top of the ring coating bath 7 to form the coating 4 on the surface of the mold 1.

Intermediate members 9 and 9′ fittable to the mold 1 may be attached to the top and bottom of the mold 1. The function of the ring 5 is as described above. As shown in FIG. 8B, a rise-regulating member 8A may be arranged above the ring seal 8 to prevent the ring 5 from rising excessively.

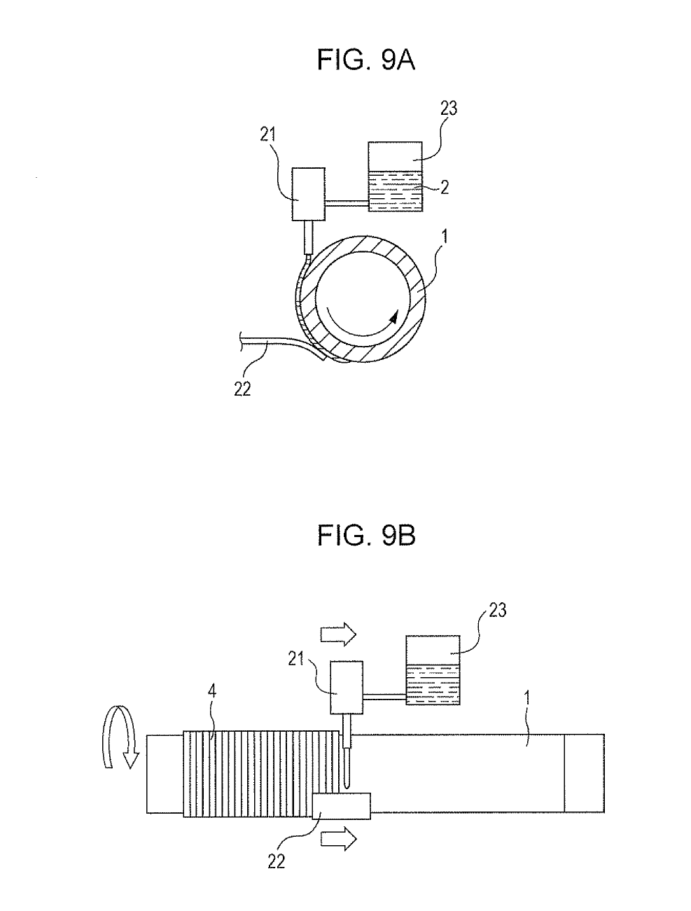

As shown in FIGS. 9A and 9B, a rotary coating apparatus may also be used for coating with the solution 2. In the rotary coating apparatus, a Mohno pump 21 is connected to a vessel 23 containing a resin material (solution 2) to adjust the discharge rate thereof, and a blade 22, such as a stainless steel blade, is attached under the solution 2. While the mold 1 is rotated, a discharge part and the blade 22 are moved from left to right in the drawings to apply the solution 2 to the circumferential surface of the mold 1.

### (3) Curing Step

In the curing step, the coating formed on the mold 1 is dried by heating. That is, in order to remove the solvent from the coating, it is dried by heating to such an extent that it does not deform when allowed to stand. The heat drying is usually performed at 80° C. to 170° C. for 30 to 60 minutes, depending on the types of resin and solvent. The heating time may be shorter at higher temperatures. The temperature may be raised stepwise or at a constant rate within the time. Hot air can also be blown for heating.

If the coating drips during the above heat drying, the mold 1 may be slowly rotated with the axial direction thereof being horizontal. The rotational speed may be 1 to 60 rpm.

### Heat Reaction Treatment Step

A film is formed only by the above heat drying if the resin material is a thermosetting resin, although further heating may be performed for high-temperature drying (heat reaction treatment). For example, if the resin material is polyimide, a polyimide film is formed by heating the coating, preferably at 250° C. to 450° C., more preferably at 300° C. to 350° C., for 20 to 60 minutes, to facilitate the condensation reaction. The residual solvent may be completely removed before the final heating temperature is reached. Specifically, the residual solvent may be removed by heating at 200° C. to 250° C. for 10 to 30 minutes, followed by slowly raising the temperature stepwise or at a constant rate.

### (4) Removing Step

After the heat drying or the heat reaction treatment, the resin film is cooled to 50° C. or less and is released from the mold 1 to obtain an endless belt.

In this step, as shown in FIGS. 1 and 2, the resin film and the covering film member 11 are removed from the mold 1 by blowing a gas (such as air) into the gap between the circumferential surface of the mold 1 and the covering film member 11 from the side of the covering film member 11 not covered with the resin film, that is, from the arrow A direction, to form airspace between the circumferential surface of the mold 1 and the resin film. The pressure of the gas blown into the gap decreases the adhesion between the mold 1 and the resin film to facilitate the release of the resin film from the mold 1.

The gas is blown from, for example, an air gun. Multiple air guns, rather than a single air gun, may be arranged to increase the volume of air. With an air gun having an elongated end that fits the curvature of the mold 1, more gas enters the gap between the mold 1 and the covering film member 11. The air pressure is preferably 0.1 to 0.6 MPa, more preferably 0.1 to 0.5 MPa. Other methods, such as air blowing, are also available.

Because the endless belt is, for example, deformed at both ends, the unusable portions (ineffective areas) are cut away, and the central effective portion (effective area) is used as a product. In addition, the endless belt may be, for example, perforated or ribbed.

Before the removal of the resin film from the mold 1, the resin film may be transferred to a cutting mold arranged at one end of the mold 1, and the ends of the transferred resin film may be cut away.

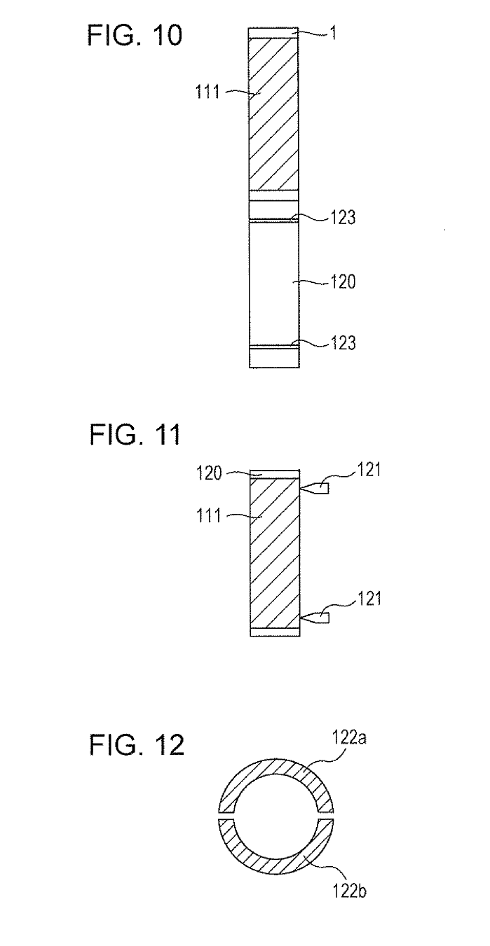

This cutting will be described with reference to FIGS. 10 to 12. In FIG. 10, a resin film 111 is formed on the circumferential surface (outer surface) of the mold 1. Before the resin film 111 is removed, a cutting mold 120 is arranged in the axial direction of the mold 1 (downward in FIG. 10). The cutting mold 120 may have an outer diameter slightly smaller than the outer diameter of the mold 1 and a length sufficient for the resin film 111 to fit thereto.

In this way, the resin film 111 is removed from the mold 1 and is then fitted to the cutting mold 120. Subsequently, as shown in FIG. 11, cutting blades 121 are put to the resin film 111, and the cutting mold 120 or the cutting blades 121 are rotated to cut the resin film 111 to the intended length. If multiple endless belts are to be produced, the corresponding number of blades may be prepared to cut the resin film 111 into multiple endless belts.

As shown in FIG. 10, for example, grooves 123 or streaks may be formed at the positions where the cutting blades 121 are put into abutment.

The cutting mold 120 may be configured such that the outer diameter thereof is made smaller than the inner diameter of the resin film 111 when the resin film 111 is fitted and is made large enough to firmly hold the resin film 111 when the resin film 111 is cut. One approach, as shown in the sectional view of FIG. 12, is to divide the cutting mold 120 into segments 122a and 122b such that the spacing therebetween is variable. After the cutting, the resin film 111 is removed from the cutting mold 120 to obtain an endless belt.

If the endless belt thus produced is to be used as a transfer belt or a contact charging belt, a conductive material may be dispersed in the polyimide.

Examples of conductive materials include carbon-based materials such as carbon black, carbon beads (granulated carbon black), carbon fibers, carbon nanotubes, and graphite; metals and alloys such as copper, silver, and aluminum; and conductive metal oxides such as tin oxide, indium oxide, antimony oxide, and the compound oxide SnO₂-In₂O₃.

If the endless belt is used as a fixing belt, a nonadhesive resin layer may be formed on the surface of the belt to facilitate removal of toner from the surface.

Examples of nonadhesive materials include fluorocarbon resins such as polytetrafluoroethylene (PTFE), tetrafluoroethylene-perfluoroalkyl vinyl ether copolymer (PFA), and tetrafluoroethylene-hexafluoropropylene copolymer (FEP). In addition, the nonadhesive resin layer may have, for example, carbon powder or barium sulfate dispersed therein.

To form a fluorocarbon resin layer, an aqueous dispersion thereof may be applied to the surface of the endless belt and be baked. Thus, to form a fluorocarbon resin layer on the surface of the belt, the fluorocarbon resin dispersion may be applied after the polyimide film is formed on the surface of the mold and is heated. It is also possible to apply and dry the polyimide precursor solution, apply the fluorocarbon resin dispersion, and then heat the coatings for facilitating the imidation reaction and baking the fluorocarbon resin.

If the endless belt is used as a fixing belt, the thickness of the polyimide film may be 25 to 500 μm, and the thickness of the fluorocarbon resin layer may be 5 to 50 μm.

### Second Exemplary Embodiment

A method for producing an endless belt according to a second exemplary embodiment of the present invention will now be described in detail for each step. The description of the first exemplary embodiment applies to the second exemplary embodiment for the points other than those described below, and a description thereof will therefore be omitted here.

### (1) Covering Step

### Covering

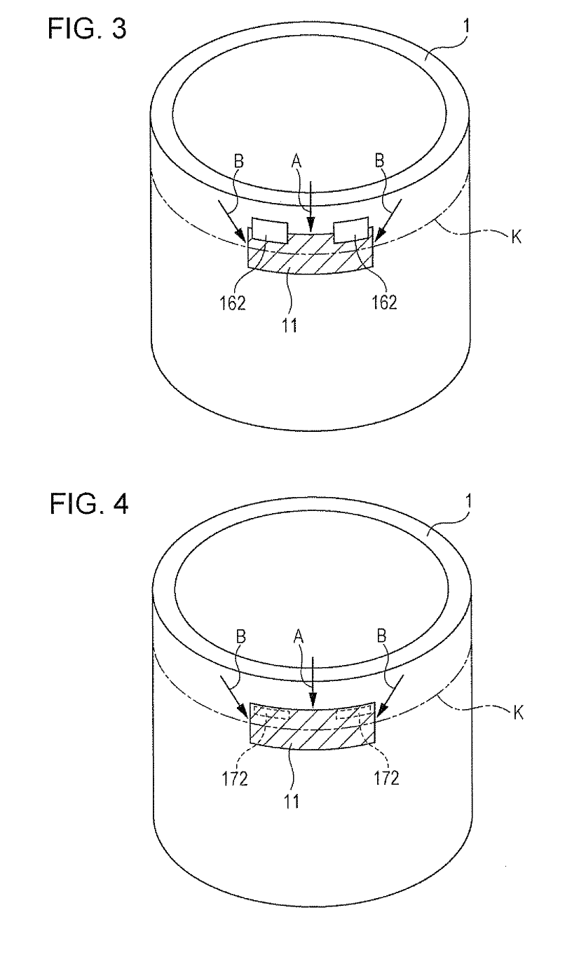

In the second exemplary embodiment, before the coating step (2), as shown in FIG. 3, the covering film member 11 is arranged on a portion of the circumferential surface of the mold 1 partially circumferentially. That is, the circumferential surface of the mold 1 is covered with the covering film member 11 by fixing the end of the covering film member 11 not to be covered with the resin film in the coating step (2) to the circumferential surface of the mold 1 with two single-sided adhesive tapes as fixing members 162.

As a modification of the second exemplary embodiment, as shown in FIG. 4, the circumferential surface of the mold 1 may be partially covered with the covering film member 11 by fixing the covering film member 11 to the circumferential surface of the mold 1 partially circumferentially with double-sided adhesive tapes, as fixing members 172, stuck to the end of the covering film member 11 not to be covered with the resin film in the coating step (2). In FIG. 4, the double-sided adhesive tapes are stuck to the inner surface of the covering film member 11, that is, the surface opposite the circumferential surface of the mold 1. Instead of the double-sided adhesive tapes, an adhesive may be used as the fixing members 172.

In the method for producing an endless belt according to the second exemplary embodiment, as shown in FIGS. 3 and 4, the covering film member 11 covers the circumferential surface of mold 1 partially circumferentially. In addition, the covering film member 11 is fixed to the mold 1 with the fixing members 162 or 172 such that, in the removing step (4), the gas is blown into the gap between the mold 1 and the covering film member 11 from a substantially circumferential direction (that is, the arrow B directions in FIGS. 3 and 4) in the area of the covering film member 11 not covered with the resin film.

This reduces the area contaminated by the resin material entering the gap between the covering film member 11 and the mold 1 in the coating step (2). In addition, the gas is also blown from the arrow B directions to form airspace between the mold 1 and the resin film, thus removing the resin film from the mold 1.

### (2) Coating Step

In the second exemplary embodiment, the resin material is applied to the circumferential surface of the mold 1 so as to partially cover the covering film member 11. In FIGS. 3 and 4, the resin material is applied to the area below the boundary K between the area where the resin material is applied and the area where the resin material is not applied.

### (4) Removing Step

After the heat drying or the heat reaction treatment, the resin film is cooled to 50° C. or less and is released from the mold 1 to obtain an endless belt.

In this step, as shown in FIGS. 3 and 4, the resin film and the covering film member 11 are removed from the mold 1 by blowing a gas (such as air) into the gap between the circumferential surface of the mold 1 and the covering film member 11 from the sides of the covering film member 11 not covered with the resin film, that is, from the arrow A and arrow B directions, to form airspace between the circumferential surface of the mold 1 and the resin film.

### Third Exemplary Embodiment

A method for producing an endless belt according to a third exemplary embodiment of the present invention will now be described in detail for each step. The description of the first exemplary embodiment applies to the third exemplary embodiment for the points other than those described below, and a description thereof will therefore be omitted here.

### (1) Covering Step

### Covering

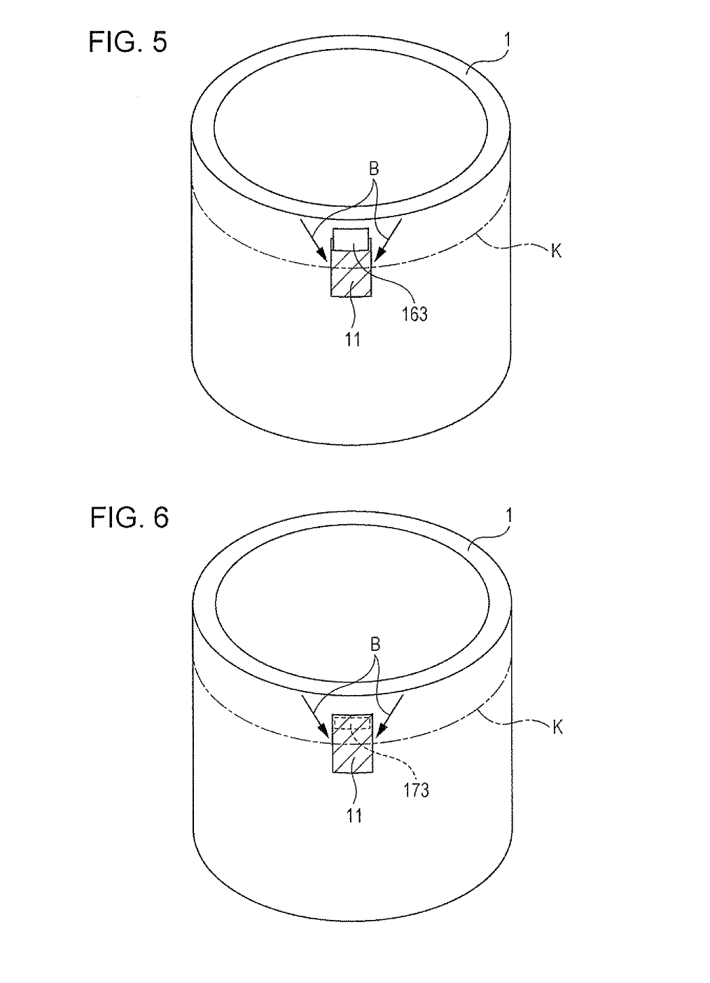

In the third exemplary embodiment, before the coating step (2), as shown in FIG. 5, the covering film member 11 is arranged on a portion of the circumferential surface of the mold 1 partially circumferentially. The circumferential surface of the mold 1 is covered with the covering film member 11 by fixing the end of the covering film member 11 not to be covered with the resin film in the coating step (2) to the circumferential surface of the mold 1 with a single-sided adhesive tape as a fixing member 163.

As a modification of the third exemplary embodiment, as shown in FIG. 6, the circumferential surface of the mold 1 may be covered with the covering film member 11 by fixing the covering film member 11 to the circumferential surface of the mold 1 partially circumferentially with a double-sided adhesive tape, as a fixing member 173, stuck to the end of the covering film member 11 not to be covered with the resin film in the coating step (2). In FIG. 6, the double-sided adhesive tape is stuck to the inner surface of the covering film member 11, that is, the surface opposite the circumferential surface of the mold 1. Instead of the double-sided adhesive tape, an adhesive may be used as the fixing member 173.

In the method for producing an endless belt according to the third exemplary embodiment, as shown in FIGS. 5 and 6, the covering film member 11 covers the circumferential surface of mold 1 partially circumferentially. In addition, the covering film member 11 is fixed to the mold 1 with the fixing member 163 or 173 such that, in the removing step (4), the gas is blown into the gap between the circumferential surface of the mold 1 and the covering film member 11 from a substantially circumferential direction (that is, the arrow B directions in FIGS. 5 and 6) in the area of the covering film member 11 not covered with the resin film.

This reduces the area contaminated by the resin material entering the gap between the covering film member 11 and the circumferential surface of the mold 1 in the coating step (2). In addition, the gas is blown from the arrow B directions to form airspace between the circumferential surface of the mold 1 and the resin film, thus removing the resin film from the mold 1.

### (2) Coating Step

In the third exemplary embodiment, the resin material is applied to the circumferential surface of the mold 1 so as to partially cover the covering film member 11. In FIGS. 5 and 6, the resin material is applied to the area below the boundary K between the area where the resin material is applied and the area where the resin material is not applied.

### (4) Removing Step

After the heat drying or the heat reaction treatment, the resin film is cooled to 50° C. or less and is released from the mold 1 to obtain an endless belt.

In this step, as shown in FIGS. 5 and 6, the resin film and the covering film member 11 are removed from the mold 1 by blowing a gas (such as air) into the gap between the mold 1 and the covering film member 11 from the sides of the covering film member 11 not covered with the resin film, that is, from the arrow B directions, to form airspace between the mold 1 and the resin film.

The foregoing description of the exemplary embodiments of the present invention has been provided for the purposes of illustration and description. At is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A method for producing an endless belt, comprising:
partially covering a circumferential surface of a cylindrical mold with a covering film member nonadhesive to the mold by fixing the covering film member with a fixing member;
applying a resin material to the circumferential surface of the mold;
curing the resin material to form a resin film; and
removing the resin film from the mold by blowing a gas into a gap between the circumferential surface of the mold and the covering film member.

2. The method for producing an endless belt according to claim 1, wherein the covering film member covers the circumferential surface of an end portion of the mold.

3. The method for producing an endless belt according to claim 1, wherein a length of the covering film member in a circumferential direction is about 0.5% to 25% of the circumference of the circumferential surface of the mold.

4. The method for producing an endless belt according to claim 1, wherein the resin film is selected from polyimide, polyamideimide, and polybenzimidazole films.

5. The method for producing an endless belt according to claim 1, wherein the gas is blown into the gap between the circumferential surface of the mold and the covering film member from a substantially circumferential direction in an area of the covering film member not covered with the resin film.

6. The method for producing an endless belt according to claim 1, wherein the resin film is removed from the mold together with the covering film member and the fixing member in the removing.

7. The method for producing an endless belt according to claim 1, wherein a length of the mold in an axial direction is about 2% to 40% longer than a length of the endless belt to be produced in the axial direction.

8. The method for producing an endless belt according to claim 1, wherein the covering film member comprises a resin.

9. The method for producing an endless belt according to claim 1, wherein the fixing member is a double-sided adhesive tape.
